(19) United States
(12) Patent Application Publication
(10) Pub. No.: US 2007/0291274 A1
(43) Pub. Date: Dec. 20, 2007

(54) Interferometric Measuring System

(76) Inventor: Pawel Drabarek, Tiefenbronn (DE)

Correspondence Address: KENYON & KENYON LLP, ONE BROADWAY, NEW YORK, NY, 10004, US

(21) Appl. No.: 10/591,502

(22) PCT Filed: Jan. 7, 2005
(86) PCT No.: PCT/EP05/50055

§ 371 Date: Aug. 20, 2007

(30) Foreign Application Priority Data
Mar. 5, 2004 (DE) 10 2004 010 754.8

(51) Int. Cl. G01B 9/02

(52) U.S. Cl. 356/478; 356/450

(57) ABSTRACT

The present invention relates to an interferometric measuring system for measuring, for example, shape deviation, position, surface properties, vibrations, of an object, the measuring system including a transmitting element having a modulation interferometer and a radiation source for short-coherent radiation, as well as a measuring probe system connected thereto for supplying the radiation via a common optical path, and further including a receiving element for analyzing the measuring radiation returning from the measuring probe system, said receiving element being combined with the transmitting element in a transmitter/receiver unit. A reduction in complexity and cost combined with enhanced application possibilities is achieved in that the measuring probe system includes a plurality of measuring probes coupled to the common optical path via respective optical paths, and in that a switching device is disposed at a coupling point between the common optical path and the respective optical paths to the measuring probes, said switching device allowing the different measuring probes to be individually brought into a bidirectionally transmitting connection with the transmitter/receiver unit for the radiation supplied by the modulation interferometer, on the one hand, and the measuring radiation, on the other hand.

### FIELD OF THE INVENTION

The present invention relates to an interferometric measuring system for measuring, for example, shape deviation, position, surface properties, vibrations, of an object, the measuring system including a transmitting element having a modulation interferometer and a radiation source for short-coherent radiation, as well as a measuring probe system connected thereto for supplying the radiation via a common optical path, and further including a receiving element for analyzing the measuring radiation returning from the measuring probe system, said receiving element being combined with the transmitting element in a transmitter/receiver unit.

### BACKGROUND INFORMATION

An interferometric measuring system of this type is described in German Published Patent Application No. 198 08 273. This known interferometric measuring system combines the methods of the heterodyne technique and dual-wavelength interferometry, which are known per se, using short-coherent radiation.

This publication further describes that this measuring device design allows, inter alia, coherence multiplexing by injecting different light wavelengths, via the different interferometer arms, in a modulation interferometer with which are preferably associated the more complex components of the measuring system; the different light wavelengths being larger than the coherence length of the light passing through the interferometer arms and subsequently being equalized in a measuring section having an optical probe system and probe outputs which are pointed toward the object surface. In this manner, only the interference phenomena occurring within the coherence length will be obtained, allowing the measurements at the object surface to be made in the connected analyzer device based on the phase differences, said analyzer device and the modulation interferometer being accommodated together in one unit. Moreover, the individual wavelengths required for multi-wavelength interferometry can be easily and suitably extracted via a beam splitting and beam receiving unit from the (relatively) broadband radiation spectrum so that the range of unambiguity of the measurement of distance and roughness or other surface properties is able to be enlarged with respect to the individual wavelengths by forming one or more synthetic wavelengths. Further advantages of the optical measuring device design including a short-coherence, dual- or multi-wavelength heterodyne interferometer are also described in this publication. Since this design is divided into the transmitter/receiver unit containing the modulation interferometer and the receiving element or analyzer device, a user-friendly and rugged system is obtained because the more complex transmitter/receiver unit is spatially separated from the measuring probe system, which may be relatively simple in design, allowing simple handling. Moreover, one advantage of this known interferometric measuring system is that, in addition to the measuring probe provided for the measurement of the surface, it has a reference probe which is connected to the modulation interferometer via an additional optical fiber arrangement and allows measurement of the orientation and also movements of a rotating table holding the measurement object. Altogether, an interferometric measuring system of this type is complex in design and expensive.

### SUMMARY OF THE INVENTION

The object of the present invention is to provide an interferometric measuring system of the type mentioned at the outset which will make it possible to achieve a reduction in complexity and cost.

For this purpose, the measuring probe system includes a plurality of measuring probes coupled to the common optical path via respective optical paths, and a switching device is disposed at a coupling point between the common optical path and the respective optical paths to the measuring probes, said switching device allowing the different measuring probes to be individually brought into a bidirectionally transmitting connection with the transmitter/receiver unit for the radiation supplied by the modulation interferometer, on the one hand, and the measuring radiation, on the other hand.

These measures allow multiple use of the relatively complex transmitter/receiver unit, which also allows stable, central placement and maintenance, including the required adjustment procedures, while the measuring probes may, for example, be positioned at suitable locations in different measuring stations of a manufacturing process.

A configuration that is convenient with respect to handling and reliable measurement results is achieved in that the common optical path and/or the respective optical paths include(s) monomode optical fibers.

Different advantageous embodiments consist in that the switching device has manually or automatically switchable control elements. Embodiment variants are obtained by providing electrically, pneumatically, hydraulically, or magnetically operated actuating elements to perform the switching.

For automation purposes, further convenient measures consist in that the switching device is controlled via a control device to which is also connected the transmitter/receiver unit for correlating the results to the respective measuring probes and, possibly, for separate evaluations. The control device can, for example, be associated with the receiver unit. These measures allow, for example, the measurements in a manufacturing process to be automatically synchronized or matched, and integrated into a production control system.

Furthermore, different arrangement options are that the measuring probes are individually assigned or assignable to a surface to be measured, form individual measurement channels of a probe unit, are arranged in groups in one or a plurality of measuring stations, are arranged in a higher-level interconnected system of measuring devices, or integrated into a combination of such arrangements. It is also possible for the measuring probes to be easily repositioned or replaced with other ones. For this purpose, standardized adaptor units may be provided for the measuring heads of the probes. These can then be evaluated separately in the control device, for which purpose the measuring heads used may also be identified automatically.

### BRIEF DESCRIPTION OF THE DRAWINGS

FIG. 1 shows a schematic block diagram view of an interferometric measuring system including a transmitter/receiver unit and a plurality of connected measuring stations.

FIG. 2 shows a block diagram view of a more detailed possible embodiment of the measuring system of FIG. 1.

### DETAILED DESCRIPTION

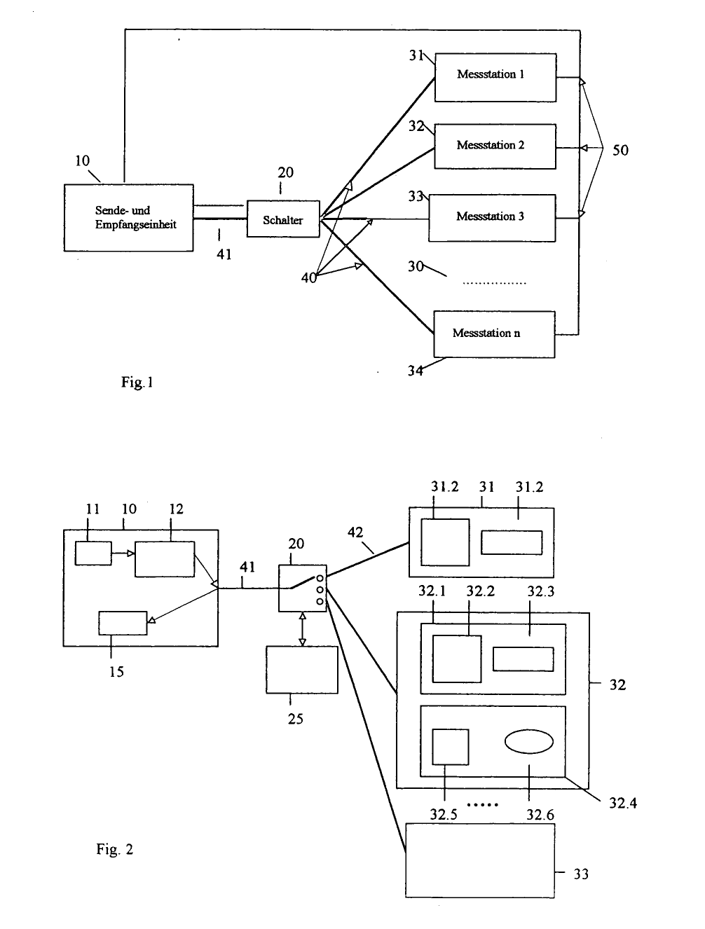

FIG. 1 shows an interferometric measuring system for measuring surface properties of an object, such as roughness, roundness, or also vibrations, the measuring system including a transmitter/receiver unit 10 and, connected thereto, a plurality of measuring stations 31, 32, 33, 34 of a measuring system 30 which are optically connected to transmitter/receiver unit 10 via a common optical path 40, a switching device 20 connected thereto, and optical paths 42 leading to the respective measuring stations 31, 32, 33, 34. Moreover, transmitter/receiver unit 10 and measuring stations 31, 32, 33, 34 are interconnected via respective electrical connections. Common optical path 40 and optical paths 42 leading to the respective measuring stations 31, 32, 33, 34 are advantageously formed by optical fibers 41 and 42, which are, in particular, monomode optical fibers.

As shown in FIG. 2, transmitter/receiver unit 10 accommodates components of the transmitting element, namely a radiation-generating unit or radiation source 11 for short-coherent broadband radiation and a downstream modulation interferometer 12, as well as components of a receiving element 15, such as photoelectric detector elements and an analyzer device, which receives and further processes the signals of the photoelectric detector elements. In the arms of modulation interferometer 12, an optical path difference is generated which is greater than the coherence length of the radiation. This optical path difference is eliminated in measuring stations 31, 32, 33, 34, or, to be more precise, in the measuring probes 32.1, 32.4 disposed therein, so that, subsequently, interferences are produced which correspond to the distances between the detected surface points, as described in greater detail in German publication DE 198 08 273 A1 mentioned at the outset. The information obtained from the interferences is evaluated in receiving element 15, it being possible to extract, for example, two different wavelengths from the broadband radiation to form a synthetic wavelength, as is also described in greater detail in the publication mentioned above. The measuring probes of measuring stations 31, 32, 33, 34 accommodate respective interferometer elements 31.1, 32.2, 32.5 in a manner known per se, said interferometer elements having a reference arm and a measuring arm, as well as measuring sections 31.2, 32.3, 32.6 which are directed to the surface to be measured and which are designed according to the surface contours to be measured, for example, in a narrow borehole. The surface properties measured are advantageously evaluated, for example, using heterodyne interferometric methods, the information being contained in the phase shift of the detected radiation.

A plurality of measuring probes 32.1, 32.4 may be accommodated in a measuring station 32, or be individually positioned at suitable locations in a complex measuring system, for example, in conjunction with first measuring station 31. Also, a plurality of measurement channels of a probe, which is able to measure, for example, different distances of a surface, can be connected to switching device 20 via the respective optical paths or optical fibers 42.

The switching device may, in the simplest case, have manually operated or automatically switchable control elements, such as sliding or rotating mirrors or other suitable optical coupling element. Switching can be performed electrically, pneumatically, hydraulically, or magnetically using corresponding controllable actuating elements. In case of automatic switching, the control is advantageously performed via a control device 25, which can also be combined with receiving element 15 and which, for example, is also accommodated in transmitter/receiver unit 10. In this connection, the evaluation can be performed such that it is matched to the measuring probe selected via switching device 20, it being possible for the signals of the different measuring probes to be evaluated differently, for example, using respectively associated subroutines. Moreover, control device 25 and/or the analyzer device of receiving element 15 can be integrated into a higher-level production control system to monitor specific manufacturing steps during a manufacturing process. In this case, the evaluation of the measuring results is coordinated or synchronized with the manufacturing process via the production control system.

The individual measuring probes, for example 32.1, 32.4, or the measuring probes contained in the other measuring stations 31, 33 or 34, can, for example, be provided with interchangeable heads which are matched to the respective measuring tasks and which also allow easy replacement in the event of a failure of a measuring section. Suitable adaptors may be provided for easy replacement. Moreover, control device 25 or the analyzer device of receiving element 15 can be designed, for example, in conjunction with electrical connections 50 and the measuring probes of measuring stations 31, 32, 33, 34, in such a manner that the measured signals are automatically correlated and recognized during evaluation.

In addition to using discrete optical elements, such as mirrors or prisms or the like, the control elements of switching device 20 for establishing an optical connection between common optical path 40 and the respective optical paths 42 can alternatively also be accomplished using integrated optical elements which do not need to be moved mechanically, but only to be controlled, for example, electrically.

The measures according to the present invention allow the transmitter/receiver unit 10 to be jointly used for a plurality of measuring probes or measuring stations 31, 32, 33, 34, and to be mounted remotely therefrom. Transmitter/receiver unit 10 can be adjusted or calibrated and controlled or monitored at a central location, remote monitoring and control being also possible via suitable data lines. The measuring probes, which are relatively simple and inexpensive in design, can be matched to the respective tasks in a correspondingly simple way.

1.-7. (canceled)

8. An interferometric measuring system for measuring a shape deviation, position, surface properties, and vibrations of an object, comprising:
a transmitting element including:
a modulation interferometer, and
a radiation source for short-coherent radiation;
a measuring probe system connected to the transmitting element and for supplying the radiation via a common optical path;
a receiving element for analyzing a measuring radiation returning from the measuring probe system, the receiving element being combined with the transmitting element in a transmitter/receiver unit, wherein:
the measuring probe system includes a plurality of measuring probes coupled to the common optical path via respective optical paths; and
a switching device disposed at a coupling point between the common optical path and the respective optical paths to the measuring probes, wherein:
the switching device allowing the different measuring probes to be individually brought into a bidirectionally transmitting connection with the transmitter/receiver unit for the radiation supplied by the modulation interferometer, on the one hand, and the measuring radiation, on the other hand.

9. The system as recited in claim 8, wherein at least one of the common optical path and the respective optical paths include monomode optical fibers.

10. The system as recited in claim 8, wherein the switching device has manually or automatically switchable control elements.

11. The system as recited in claim 10, wherein electrically, pneumatically, hydraulically, or magnetically operated actuating elements are provided for switching.

12. The system as recited in claim 8, wherein the switching device is controlled via a control device to which is also connected the transmitter/receiver unit for correlating the results to the respective measuring probes and for separate evaluations.

13. The system as recited in claim 8, wherein the measuring probes are individually assigned or assignable to a surface to be measured, form individual measurement channels of a probe unit, are arranged in groups in one or a plurality of measuring stations, are arranged in a higher-level interconnected system of measuring devices, or integrated into a combination of such arrangements.
